(19) United States
(12) Patent Application Publication
(10) Pub. No.: US 2004/0067247 A1
(43) Pub. Date: Apr. 8, 2004

(54) Composition for combating/repelling insects, birds, dirts and parasites

(76) Inventors: Xavier De Sloovere, Anzegem (BE); Didier Desschans, Kortrijk-Heule (BE); Gino Sirejacob, Evergem (BE)

Correspondence Address: HOVEY WILLIAMS LLP, 2405 GRAND BLVD., SUITE 400, KANSAS CITY, MO, 64108, US

(21) Appl. No.: 10/613,956

(22) Filed: Jul. 3, 2003

Related U.S. Application Data
(63) Continuation-in-part of application No. 10/322,285, filed on Dec. 17, 2002.

(30) Foreign Application Priority Data
Sep. 27, 2002 (WO) PCT/BE02/00149

(51) Int. Cl. A01N 25/08

(52) U.S. Cl. 424/409

(57) ABSTRACT

Composition for combating or repelling at least one living organism selected from the group consisting of insects, molluscs, acarides, mites, ticks and parasites or for repelling water, dirt or birds, said composition comprising at least as active agent hydrophobic silicon (Si) containing particles with an average primary particle size of less than 100 nm.

### RELATED APPLICATIONS

This application is a continuation-in-part application of co-pending application Ser. No. 10/322,285, filed Dec. 17, 2002 and claims the benefit of PCT application PCT/BE02/00149, filed Sep. 27, 2002; the disclosures of which and the entire contents of which are incorporated herein by reference.

### BACKGROUND OF THE INVENTION

1. Field of the Invention

The invention relates to a composition for combating or repelling insects, molluscs, acarides, mites, dirts, birds and parasites causing health problems to humans and animals, such as birds.

2. The Prior Art

As stated in U.S. Pat. No. 3,980,784, “the control of animal parasites is one of the oldest and most important problems of the animal husbandry industry. Many types of parasites afflict virtually all species of animals. Most animals are afflicted by free-flying parasites such as flies, crawling ectoparasites such as lice and mites, burrowing parasites such as bots and grubs, and by microscopic endoparasites such as coccidia, as well as by larger endoparasites such as worms. Thus, the control of parasites even in a single host species is a complex and many-sided problem. The insect and acarina parasites which consume living tissues of a host animal are particularly harmful. The group includes parasites of all the economic animals, including ruminant and monogastric mammals and poultry, and of companion animals such as dogs as well.”

Up to now, insects, mites and parasites causing health problems to chickens and other poultry, horses and other livestock, or humans are treated with chemical agents causing side effects, such as due to its release in water (river, pools, lakes, etc.), air, ground, soil, etc. causing environmental problems and causing problem for the health of the poultry, livestock or humans.

Due to said side effects, legislation prevents the use of more and more insecticides, anti parasite compounds, etc.

Furthermore, due to the limited number of authorized insecticides, etc. (i.e. admitted by law), the insects and parasites become more and more resistant to said compounds, i.e. said compounds begin to be inefficient against insects and parasites.

It has already been proposed (U.S. Pat. No. 4,169,069) to use SiO2 particles with a particle size of 10 to 500 μm, as suitable porous inert carrier for active agent and to coat said particles with a polysiloxane, so as to delay the release of the active agent. Insecticide needs an immediate action and not a delayed action.

It has also been proposed (U.S. Pat. No. 4,678,774) to combine avermectin with a uncoated hydrophilic amorphous silicon dioxide, so as to enhance the insecticidal activity of avermectin. As stated in said document hydrophilic amorphous silicon dioxide has no insecticidal effect. Tests made by applicants have confirmed that uncoated hydrophilic silicon dioxide had no effect for killing parasites.

It has still been proposed (U.S. Pat. No. 4,945,088) to prepare insecticidal wettable powder prepared by mixing calcined white carbon with a insecticidal compound. The calcined white carbon particles have a size not less than 10 μm and is used as carrier for avoiding an oil separation of the insecticide in an aqueous suspension. WO 01/36084 and WO 01/80645 disclose an aerated gel composition comprising 2 to 5% by weight hydrophobic silica and 0.2 to 5% by weight of gelling agent selected from the group consisting of xanthan gum, sodium alginate and neutralised carboxyvinyl polymer. In said documents, no reference at all is made to the particle size of the silica particles.

The preferred particles used in said documents are Carbosil TS720, high purity silica treated with a dimethyl silicon fluid, said particles having an aggregate particle size of 200 to 300 nm and a BET surface of 115 m²/g. The silica content of the composition is between 2 and 5%, higher concentration being considered as being a cause of dusty nuisance.

It has now been observed that Si containing nanoparticles (free of insecticide compound) which are preferably provided with a silicon containing coating and which are preferably associated with one or more gelling agents, are extremely efficient for killing insects.

### BRIEF DESCRIPTION OF THE INVENTION

The present invention has for subject matter a composition for combating (in addition to the commonly understood meanings or recognized dictionary definitions, this term as specifically used herein refers to controlling or fighting by reducing the activity of, killing, eliminating, and reducing the viable offspring of) or repelling insects, molluscs (especially stylommatophora molluscs), acarides (or dust mites), water, dirt, birds and worms, said composition comprising at least as active agent silicon containing particles, said particles having an average primary particle size of less than 100 nm, advantageously of less than 50 nm, preferably comprised between 5 and 40 nm, most preferably between 5 and 20 nm, whereby the silicon containing particles are hydrophobic silicon containing particles and/or particles provided with a hydrophobic silicon containing coating and/or hydrophilic silicon containing particles and/or particles provided with a hydrophilic silicon containing coating. The outer coating of the particles or at least a portion of said outer coating is preferably different from a coating obtained by a simple hydrolysis of the silicon containing particles or SiO₂ particles in presence of water or humidity.

The silicon containing coating is for example a hydrophilic coating or a hydrophobic coating containing at least carbon atom or a mixture thereof. Hydrophobic coating seems to be preferred. The hydrophilic coating or hydrophobic coating is advantageously the outer coating. Possibly the silicon or siliceous containing particles are provided with a hydrophilic coating and with a hydrophobic coating. Preferably, in this case the hydrophobic coating is the outer coating. The hydrophilic and/or hydrophobic active coating can be overcoated with a control release layer, such as a water soluble layer, an entero soluble layer, etc.

While it is still unclear how the composition is working, it appears that the hydrophobic character of the nanoparticles is of importance. It seems that the hydrophobic nanoparticles are acting on the health of the treated insects and molluscs, acarides, as well as on the health of the eggs, larvae, pupae, nymphs, etc. of said insects and molluscs, acarides, whereby avoiding the exponential population growth of the insects, molluscs, and acarides due to the hatching of the exponential number of insects' eggs, molluscs' eggs, acarides' eggs.

Parasites in the meaning of the present specification means also fungus, bacterium, virus, algae, etc.

Dirt in the meaning of the present specification means dirty aqueous compositions, dirty aqueous suspensions or pasta, water, dust, animal waste, grafitti, acid aqueous composition, acid water, acid rain, excrements, animal based manure, paint (water and non water based paints), etc.

The silicon containing particles are advantageously siliceous containing particles and are for example, silicon dioxide, precipitated silica, fumed silica, silicates, bentonite, synthetic hydrated silicon dioxide, diatomaceous earth, clays, attapulgite, hectorite clay, montmorillonite clay, silica gel particles, zeolite (natural or synthetic), kaolinite, smectite, illite, halloysite, vermiculite, sepiolite, beidelite, palygorskite, talc, etc. and mixtures thereof. Synthetic silicon containing particles are preferred, as it enables a good control of the particle size. It has to be noted that the siliceous particles can form agglomerates and that the average primary particle size is the size of a particle of the agglomerate. Synthetic amorphous silicon dioxide, precipitated silica, fumed silica, pyrogenic synthetic amorphous silica, bentonite and mixtures thereof are preferred as nanoparticles.

The silicon containing particles comprises according to an advantageous form some aluminum.

The silicon or siliceous containing nanoparticles have advantageously a Si content (based on the ignited material and calculated as SiO₂) greater than 5% by weight, advantageously greater than 10% by weight, such as greater than 20% by weight. The Si content (based on the ignited material and calculated as SiO₂) is more advantageously greater than 50% by weight, preferably greater than 75%, such as greater than 90%, most preferably greater than 95%, such as greater than 99%, or even more than 99.5%, for example 99.8% or more.

The siliceous containing particles before its coating may contain some other atoms, such as one or more atoms selected from the group consisting of Ca, Mg, Al, Na, Ti, Fe, halogen atom. However, after ignition of the particles, the siliceous containing nanoparticles are substantially free of said compound.

The silicon containing particles can be provided with a silicon containing coating, such as a hydrophobic coating and/or a hydrophilic coating. The particles can also be particles only provided with a silicon containing coating, such as a hydrophobic coating and/or a hydrophilic coating.

The coating of the nanoparticles, advantageously silicon containing nanoparticles is very thin and represent generally less than 20% of the weight of the uncoated nanoparticles, for example between 3 and 10%. The coating is preferably complete, even if some result can be obtained with partial coating on nanoparticles.

Advantageously, the hydrophobic or hydrophilic coated silicon particles (not ignited) have a SiO₂ content of at least 50% by weight, preferably of at least 70%, most preferably of at least 80%, such as more than 90% by weight.

According to a detail of an embodiment, the hydrophobic or hydrophilic coated siliceous particles have a BET surface area of at least 40 m²/g, such as more than 75 m²/g, advantageously of at least 100 m²/g, preferably of at least 125 m²/g, most preferably at least 150 m²/g.

The hydrophobic or hydrophilic coated silicon or siliceous particles have preferably a pH comprised between 1 and 13, advantageously between 3 and 13, preferably between 3.5 and 8.5, such as between about 4 and about 6, said pH being measured in a water/methanol medium (1 volume water/1 volume methanol) with a solid content of 4% by weight.

The hydrophobic or hydrophilic coated silicon or siliceous nanoparticles have advantageously a tapped density greater than 40 g/l, such as greater than 50 g/l, preferably greater than 75 g/l, most preferably greater than 100 g/l (density according to the norm DIN iso 787/XI, August 1983).

The hydrophobic or hydrophilic coated siliceous particles are advantageously siliceous particles provided with a functionalized silane or siloxane (or polysiloxane) coating or with an organofunctional silane or siloxane (or polysiloxane) coating.

Advantageously, the structure of the silicon or siliceous containing particles are modified before and/or during and/or after making the treatment, preferably after the coating treatment, most preferably after a drying step (before and/or during and/or after a curing step). For example, the agglomerated nanoparticles forming agglomerates are submitted to treatment for breaking the agglomerates, for example by milling, by micronizing, by ultrasound treatment, by lyophilization, by spraying, by grinding, by mixing in a bath or liquid medium (intensive mixing), and combinations thereof. Reference can be done to US20020077388 for disclosing a specific method for modifying the structure of silicas or silicates.

Advantageously, the hydrophobic or hydrophilic coated silicon or siliceous particles are provided with a hydrophobic silicon coating comprising at least carbon atoms and at least one or more atoms selected from the group consisting of P,S,O,N, Cl, F, I. For example, the hydrophobic silicon coating comprises at least one function selected from the group consisting of amino, ureido, thio, halogeno hydrocarbon group, cyano, isocyanato, and mixture thereof. Specific possible examples of coatings are: substituted or unsubstituted silane esters, substituted or unsubstituted vinyl silane, substituted or unsubstituted methacryloxysilane, substituted or unsubstituted epoxysilane, substituted or unsubstituted sulfur silane, substituted or unsubstituted sulfur siloxane or polysiloxane, mercapto silane or siloxane or polysiloxane, cyclotetrasiloxane, substituted or unsubstituted amino silane, ureido silane, isocyanato silane, substituted or unsubstituted chlorinated silane (such as chlorosilane), substituted or unsubstituted fluorinated silane, substituted or unsubstituted polyalkoxy or polyorganoalkoxysiloxanes, disilazanes (such as hexamethyldisilazane), methacrylic silane, silicon oil, modified silicon oil, silicon fluid, modified silicon fluid, ammonium salts (such as alkyl ammonium salts), phosphonium salts (such as alkyl phosphonium salts), etc. and mixtures thereof.

According to an advantageous composition, the composition comprises for example at least 0.5% by weight hydrophobic silicon containing particles, preferably at least 2% by weight hydrophobic silicon containing particles, most preferably at least 7% by weight hydrophobic silicon containing particles, especially at least 15% by weight hydrophobic silicon containing particles, such as between 20 and 75%, such as 25% by weight, 35% by weight, 45% by weight, 55% by weight.

According to an advantageous embodiment, the composition comprises at least hydrophobic bentonite particles. It has been observed that hydrophobic bentonite particles with an average particle size of 10 to 100 μm, such as a particle size from 10 to 40 μm have already some efficiency for combating insects and parasites. However, especially when bentonite is used alone, the average primary particle size of bentonite is below 100 nm, such as comprised between 10 nm and 40 nm. Larger bentonite particles with a size of 1 μm to 100 μm are converted in smaller particles when mixed in an aqueous medium, said smaller particles having then a primary particle size of less than 100 nm, advantageously an average primary particle size of less than 100 nm, preferably an average primary particle size comprised between 10 and 40 nm.

According to an another advantageous embodiment, the composition comprises at least hydrophobic hectorite particles, possibly mixed with bentonite particles. It has been observed that hydrophobic hectorite particles, possibly mixed with bentonite particles with an average particle size of 10 to 100 μm, such as a particle size from 10 to 40 μm, have already some efficiency for combating insects and parasites. However, especially when hectorite is used alone or in mixture with bentonite, the average primary particle size of hectorite/bentonite is below 100 nm, such as comprised between 10 nm and 40 nm. Larger hectorite particles with a size of 1 μm to 100 μm are converted in smaller particles when mixed in an aqueous medium, said smaller particles having then a primary particle size of less than 100 nm, advantageously an average primary particle size of less than 100 nm, preferably an average primary particle size comprised between 10 and 40 nm. When using a mixture bentonite/hectorite, the mixture comprises for example from 0.1% to 99.9% by weight bentonite and from 99.9 to 0.1% by weight hectorite, advantageously from 1 to 99% by weight bentonite and from 99% to 1% by weight hectorite, most preferably between 10 and 90% by weight bentonite and from 90% to 10% by weight hectorite, such as mixture comprising 25% hectorite+75% bentonite, mixture comprising 50% hectorite and 50% bentonite, micture comprising 75% hectorite and 25% bentonite, etc.

According to preferred composition, the composition comprises

from 0.01% by weight to 99.99% by weight (such as between 0.1% and 50%) of hydrophobic silica, and

from 0.01% by weight to 99.99% by weight (such as between 0.1% and 50%) of hydrophobic clay, especially hydrophobic bentonite and/or hectorite and/or a mixture thereof.

In case of such a composition, the hydrophobic silica particles are nanoparticles with an average primary particle size of less than 100 nm, advantageously less than 50 nm, preferably comprised between 5 and 40 nm, while the hydrophobic clay can be or not nanoparticles. The hydrophobic clay, especially hydrophobic bentonite, has for example an particle size of less than 100 μm, advantageously less than 50 μm, such as a size comprised between 1 and 50 μm, preferably between 10 μm and 40 μm, or even less than 10 μm. It has been observed that the presence of hydrophobic clay had a synergistic effect on the working or efficiency of silica particles. The hydrophobic clay, especially bentonite and/or hectorite and/or mixtures thereof, especially when used without silica particles, has an average primary particle size of less than 100 nm, preferably of less than 50 nm, such as comprised between 10 nm and 40 nm, most preferably between 10 nm and 20 nm.

The composition has advantageously the form of an aqueous dispersion. According to a preferred embodiment, the composition further comprises at least a gelling agent, advantageously an aqueous gelling agent.

Advantageously, the composition comprises at least a gelling agent selected from the group consisting of water soluble gelling agent and water dispersible gelling agent.

For example, the composition comprises from 0.01 to 10% by weight (advantageously less than 5% by weight, such as 0.2% by weight, 0.3% by weight, 0.5% by weight, 0.7% by weight, 1% by weight, 1.5% by weight, 2% by weight, 2.5% by weight, 3% by weight, 4% by weight) of gelling agent selected from the group consisting of water soluble gelling agent and water dispersible gelling agent.

The composition preferably comprises at least one gum selected from the group consisting of guar gum, xanthan gum, scleroglucan and mixtures thereof.

Most preferably, the composition comprises at least two gums selected from the group consisting of guar gum, xanthan gum and scleroglucan.

According to an embodiment, the composition further comprises at least one solid agent selected from the group consisting of hydrophobic zeolite, hydrophobic carbonate, and mixtures thereof. The further solid present in the composition has advantageously a particle size greater than 100 nm.

It seems that the composition of the invention has an improved efficiency, when the composition comprises a mixture of particles with an average primary size of less than 100 nm, advantageously less than 50 nm, preferably comprised between 10 nm and 40 nm, and of particles with an average particle size greater than 0.5 μm, advantageously with an average particle size comprised between 0.5 and 100 μm, advantageously comprised between 10 μm and 50 μm.

The composition has advantageously the form of a water dispersible powder. According to a specific embodiment, the composition is an aqueous composition with a content in hydrophobic silica containing particles with a size of less than 100 nm comprised between 0.5 and 70% by weight, advantageously between 1 and 60% by weight, preferably more than 20% by weight, such as between 20 and 50% by weight, for example 25% by weight, 30% by weight, 40% by weight and 50% by weight.

According to a preferred embodiment, the composition further comprises an agent selected from the group consisting of povidone, povidone derivatives, and mixtures thereof. Specific povidones are Polyvinylpyrrolidone (homopolymer), cross linked vinylpyrrolidone (homopolymers), alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, etc. and mixtures thereof. The povidone or povidone derivative content in the composition is for example comprised between 0.1% by weight and 10% by weight, advantageously between 0.2 and 5%, such as 0.25% by weight, 0.5% by weight, 0.8% by weight, 1% by weight, 2% by weight and 3% by weight.

The composition possibly further comprises one or more elements selected from the group consisting of compounds suitable for attracting the insect or worm or acaride or molluscs or mites or ticks to be combated or repelled, compounds suitable for repelling the insect or worm or acaride or molluscs or mites or ticks to be combated or repelled or the water, dirt or birds to be repelled, insecticide compounds, molluscicides (compound effective for killing or destroying molluscs), biocide, acaricides (compound effective for killing or destroying acarides), rodenticides (compound effective for killing or destroying rodents, such as rats), solvents, dispersant, tensioactive, surfactant, germicide, antibacterial agent, herbicides, growth regulators, chitin inhibitor, antifungal agents, disintegrant, antialgae, hormones, chelating agents, essential oils, plant extracts, water retention agent, food, preservatives, algicide, chitin, chitin derivatives, virucides, anticorrosion agents, vitamins (such as vitamin E), benzothiazole, isothiazole, gums (such as locust gum, arabic gum, etc.), cellulosic derivatives (methylcellulose, methylpropylcellulose, etc.), polyacrylic ester, polymethacrylic ester, polysaccharide, and mixtures thereof. Compounds having a high efficiency for repelling birds are oleoresin capsicum, capsicum, bitrex, and mixtures thereof.

The composition is for example in a form selected from the group consisting of a powder, a suspension, granules, pellets, food additives, gel, aerated gel, colloidal medium, cream and combinations thereof.

According to an embodiment, the composition comprises at least one compound selected from the group consisting of additives and fillers, the weight ratio hydrophobic silicon containing nanoparticles with a primary particle size lower than 100 nm/compound selected from the group consisting of additive and filler being comprised between 0.001 and 1000, advantageously 0.01 and 100, such as between 0.2 and 50 or between 0.5 and 20.

According to a possible embodiment, the hydrophobic silicon containing particles are particles provided with an outer layer selected from the group consisting of water soluble layers, entero soluble layers and combinations thereof.

According to still a further embodiment, the silicon containing particles are provided with at least a hydrophilic silicon containing coating and with at least a hydrophobic silicon containing coating.

Preferably, the silicon or siliceous containing particles are particles with a modified structure.

The invention relates also to a composition for combating or repelling insects, molluscs, acarides, mites, ticks and parasites or for repelling water, dirt or birds, said composition comprising at least as active agent hydrophobic and/or hydrophilic particles with a primary particle size of less than 100 nm, advantageously less than 50 nm, preferably between 5 and 40 nm, and at least two gums selected from the group consisting of guar gum, xanthan gum and scleroglucan. It has been observed that the efficiency of nanoparticles was increased by the use of a combination of two or three gums.

The gum content of said composition is for example comprised between 0.01% by weight and 10% by weight, advantageously between 0.2 and 5% by weight. For example, the composition comprises from 0.01 to 10% by weight (advantageously less than 5% by weight, such as 0.2% by weight, 0.3% by weight, 0.5% by weight, 0.7% by weight, 1% by weight, 1.5% by weight, 2% by weight, 2.5% by weight, 3% by weight, 4% by weight) of gelling agent selected from the group consisting of water soluble gelling agent and water dispersible gelling agent.

Advantageously, the composition further comprises an agent selected from the group consisting of povidone, povidone derivatives, and mixtures thereof. Preferred povidone is PVP. Specific povidones are Polyvinylpyrrolidone (homopolymer), cross linked vinylpyrrolidone (homopolymers), alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, etc. and mixtures thereof.

The povidone and/or povidone derivatives is present in the composition at a rate advantageously comprised between 0.01 and 10% by weight, preferably between 0.1 and 5% by weight. The povidone or povidone derivative content in the composition is for example comprised between 0.1% by weight and 10% by weight, advantageously between 0.05 and 8%, such as 0.1% by weight, 0.25% by weight, 0.5% by weight, 0.8% by weight, 1% by weight, 2% by weight and 3% by weight.

Still a further invention is a composition for combating insects, molluscs, acarides, mites, ticks and parasites or for repelling water, dirt or birds, said composition comprising at least as active agent hydrophobic and/or hydrophilic particles with a primary particle size of less than 100 nm, advantageously less than 50 nm, preferably comprised between 5 and 40 nm, and at least one agent selected from the group consisting of povidone, povidone derivatives, and mixtures thereof. Indeed, it has been observed that the presence of povidone and povidone derivatives increases the efficiency of the nanoparticles.

The povidone and/or povidone derivatives is present in the composition at a rate advantageously comprised between 0.01 and 10% by weight, preferably between 0.1 and 5% by weight. The povidone or povidone derivative content in the composition is for example comprised between 0.1% by weight and 10% by weight, advantageously between 0.2 and 5%, such as 0.25% by weight, 0.5% by weight, 0.8% by weight, 1% by weight, 2% by weight and 3% by weight.

According to a specific embodiment, the composition for combating insects, molluscs, acarides, mites, ticks and parasites or for repelling water or dirt or birds, comprises at least as active agent:

Active silicon or siliceous containing particles, said particles having an average primary particle size of less than 100 nm, advantageously of less than 50 nm, preferably comprised between 5 and 40 nm, whereby the siliceous containing particles are provided with a hydrophilic silicon containing coating, advantageously with an outer hydrophilic silicon containing coating, and

Active silicon or siliceous containing particles, said particles having an average primary particle size of less than 100 nm, advantageously of less than 50 nm, preferably comprised between 5 and 40 nm, whereby the silicon or siliceous containing particles are provided with a hydrophobic silicon containing coating, advantageously with an outer hydrophobic silicon containing coating, the weight ratio active silicon or siliceous containing particles with a (outer) hydrophilic silicon containing coating/active coated siliceous containing particles with a (outer) hydrophobic silicon containing coating being comprised between 1/100 and 100/1, advantageously between 1/50 and 1/2, preferably between 1/50 and 1/1.

Advantageously, the composition further comprises at least a gelling agent, preferably an aqueous gelling agent, water soluble gelling agent and water dispersible gelling agent.

Preferably, the composition comprises from 0.01 to 10% by weight of gelling agent selected from the group consisting of water soluble gelling agent and water dispersible gelling agent.

The composition comprises for example at least one gum selected from the group consisting of guar gum, xanthan gum, scleroglucan and mixtures thereof, preferably at least two gums selected from the group consisting of guar gum, xanthan gum and scleroglucan.

According to an embodiment, the composition is an aqueous composition with a content in hydrophilic silica containing particles with a primary particle size of less than 100 nm (advantageously less than 50 nm, preferably comprised between 5 and 40 nm) comprised between 20 and 50% by weight.

According to a further detail of a preferred embodiment, the composition further comprises an agent selected from the group consisting of povidone, povidone derivatives, and mixtures thereof. The povidone or povidone derivative content in the composition is for example comprised between 0.1% by weight and 10% by weight, advantageously between 0.2 and 5%, such as 0.25% by weight, 0.5% by weight, 0.8% by weight, 1% by weight, 2% by weight and 3% by weight.

The invention relates also to a composition for combating or repelling insects, aracides, mites, ticks, molluscs and parasites or for repelling water or dirt or birds, said composition comprising at least as active agent coated siliceous containing particles, said particles having an average primary particle size of less than 100 nm, advantageously of less than 50 nm, preferably comprised between 5 and 40 nm, whereby the coating comprises a portion which is a hydrophilic silicon containing coating and another portion which is a hydrophobic silicon containing coating.

In the composition of the invention, the hydrophobic coating or the hydrophilic coating forms an outer coating of the siliceous containing particles.

According to a possible embodiment, the (outer) hydrophobic coating or the (outer) hydrophilic coating is overcoated with a water soluble layer or an entero soluble layer.

Compositions of the invention show activity against a number of insects, molluscs, acarides, mites, ticks, dirt and various endo and ecto parasites, especially blood sucking parasites, ants, fleas, ticks, lynes, termites, bugs, beetles, springtails, gnaks, styllommatophora molluscs, etc.

More specifically, compositions of the invention show activity against members of the insect order Lepidoptera such as the beet armyworm, tobacco budworm, codling moth and cabbage looper. Other typical members of this order include the southern armyworm, cutworms, clothes moths, Indian meal moth, leaf rollers, corn earworm, cotton bollworm, European corn borer, imported cabbage worm, pink bollworm, bagworms, Eastern tent caterpillar, sod webworm, and fall armyworm.

Compositions of the invention also show activity against members of the order Coleoptera (the beetles and weevils such as the Colorado potato beetle, spotted and striped cucumber beetles, Japanese beetle, and boll weevil) and Diptera (the true flies such as the house fly, mosquitoes, fruit flies, stable and horn flies, and leaf miners).

Compositions of the invention also show activity against members of the order Hempitera (true bugs such as plant bugs, stink bugs, and chinch bugs), Homoptera (such as the aphids, leafhoppers, planthoppers, whiteflies, scales, and mealybugs), Mallophaga (chewing lice), Anoplura (sucking lice), house dust, mites, dust mites, scabies mite (sarcoptes scabier) book worms, schurft mites, fruit fly, fruit worms, leave lices, Thysanoptera (thrips), Orthoptera (such as cockroaches, grasshoppers, and crickets), Siphonaptera (fleas), Isoptera (termites), and members of the Hymenoptera order Formicidae (ants), as well as the eggs, larvae and/or purpae and/or nymphs thereof.

Compositions of the invention shows activity against mites and ticks of the order Acari, for example, the two-spotted spider mite. Other typical members of this order include plant parasites such as the citrus red mite, European red mite, and citrus flat mite, and animal parasites such as the mange mite, scab mite, sheep scab mite, chicken mite, scalyleg mite, depluming mite and dog follicle mite.

Specific representative antrhopod pests which can be controlled by the composition of the invention include the following: Amblyomma americanum (Lone-star tick), Amblyomma maculatum (Gulf Coast tick), Argas persicus (fowl tick), Boophilus microplus (cattle tick), Chorioptes spp. (mange mite), Demodex bovis (cattle follicle mite), Demodex canis (dog follicle mite), Dermacentor andersoni (Rocky Mountain spotted fever tick), Dermacentor variabilis (American dog tick), Dermanyssus gallinae (chicken mite), Ixodes ricinus (common sheep tick), Knemidokoptes gallinae (deplumming mite), Knemidokoptes mutans (scaly-leg mite), Otobius megnini (ear tick), Psoroptes equi (scab mite), Psoroptes ovis (scab mite), Rhipicephalus sanguineus (brown dog tick), Sarcoptes scabiei (mange mite), Aedes (mosquitoes), Anopheles (mosquitoes), Culex (mosquitoes), Culiseta, Bovicola bovis (cattle biting louse), Callitroga homnivorax (blowfly), Chrysops spp. (deer fly), Cimex lectularius (bed bug), Cochliomyia spp. (screwworm), Ctenocephalides canis (dog flea), Ctenocephalides felis (cat flea), Culicoides spp. (midges, sandflies, punkies, or no-see-ums), Damalinia ovis (sheep biting louse), Dermatobia spp. (warble fly), Gasterophilus haemorrhoidalis (nose bot fly), Gasterophilus intestinalis (common horse bot fly), Gasterophilus nasalis (chin fly), Glossina spp. (tsetse fly), Haematobia irritans (horn fly, buffalo fly), Haematopinus asini (horse sucking louse), Haematopinus eurysternus (short nosed cattle louse), Haematopinus ovillus (body louse), Haematopinus suis (hog louse), Hydrotaea irritans (head fly), Hypoderma bovis (bomb fly), Hypoderma lineatum (heel fly), Linognathus ovillus (body louse), Linognathus pedalis (foot louse), Linognathus vituli (long nosed cattle louse), Lucilia spp. (maggot fly), Melophagus ovinus (sheep ked), Musca spp. (house fly, face fly), Oestrus ovis (nose bot fly), Pediculus spp. (lice), Phlebotomus spp. (sandfly), Phormia regina (blowfly), Psorophora spp. (mosquito), Pthirus spp. (lice), Reduvius spp. (assassin bug), Simulium spp. (black fly), Solenopotes capillatus (little blue cattle louse), Stomoxys calcitrans (stable fly), Tabanus spp. (horse fly), Tenebrio spp. (mealworms), Triatoma spp. (kissing bugs).

More specific parasites which can be combated with compositions of the invention are:

Parasites of Horses:

horsefly, adult, bloodsucking, as well as their larvae and pupae

stable fly, adult, bloodsucking, as well as their larvae and pupae

black fly, adult, bloodsucking, as well as their larvae and pupae

horse sucking louse, immature, adult, bloodsucking, as well as their larvae and pupae

mange mite, nymph, adult, skin-burrowing, as well as their larvae and pupae

scab mite, adult, skin-eating, as well as their larvae and pupae

common horse bot fly, larva, migrating in alimentary canal, as well as their larvae and pupae

chin fly, larva, migrating in alimentary canal, as well as their larvae and pupae

nose bot fly, larva, migrating in alimentary canal, as well as their larvae and pupae

Parasites of Bovines:

horn fly, adult, bloodsucking, as well as their larvae and pupae

cattle biting louse, adult, skin-eating, as well as their larvae and pupae

cattle bloodsucking louse, nymph, adult, bloodsucking, as well as their larvae and pupae

tsetse fly, adult, bloodsucking, as well as their larvae and pupae

stable fly, adult, bloodsucking, as well as their larvae and pupae

horse fly, adult, bloodsucking, as well as their larvae and pupae

cattle follicle mite, adult, skin-burrowing, as well as their larvae and pupae

cattle tick, larva, nymph, adult, bloodsucking, as well as their larvae and pupae

ear tick, nymph, bloodsucking, as well as their larvae and pupae

Gulf Coast tick, adult, bloodsucking, as well as their larvae and pupae

Rocky Mountain spotted-fever tick, adult, bloodsucking, as well as their larvae and pupae

lone star tick, adult, bloodsucking, as well as their larvae and pupae

heel fly, larva, migrating through the body, as well as their larvae and pupae

bomb fly, larva, migrating through the body, as well as their larvae and pupae

blowfly, larva, infesting wounds, as well as their larvae and pupae

assassin bug, adult, bloodsucking, as well as their larvae and pupae

Parasites of Swine, as well as their larvae and pupae

hog louse, nymph, adult, bloodsucking, as well as their larvae and pupae

chigoe flea, adult, bloodsucking, as well as their larvae and pupae

Parasites of Sheep and Goats:

bloodsucking body louse, adult, bloodsucking, as well as their larvae and pupae

bloodsucking foot louse, adult, bloodsucking, as well as their larvae and pupae

sheep ked, adult, bloodsucking, as well as their larvae and pupae

sheep scab mite, nymph, adult, skin-eating, as well as their larvae and pupae

nose fly, larva, migrating in the sinuses, as well as their larvae and pupae

greenbottle fly, larva, infesting wounds, as well as their larvae and pupae

black blowfly, larva, infesting wounds, as well as their larvae and pupae secondary screwworm, larva, infesting wounds, as well as their larvae and pupae

Parasites of Poultry:

bed bug, nymph, adult, bloodsucking, as well as their larvae and pupae

Southern chicken flea, adult, bloodsucking, as well as their larvae and pupae

fowl tick, nymph, adult, bloodsucking, as well as their larvae and pupae

chicken mite, nymph, adult, bloodsucking, as well as their larvae and pupae

scaly-leg mite, adult, skin-burrowing, as well as their larvae and pupae

depluming mite, adult, skin-burrowing, as well as their larvae and pupae

Parasites of Dogs:

horse fly, adult, bloodsucking, as well as their larvae and pupae

stable fly, adult, bloodsucking, as well as their larvae and pupae

mange mite, nymph, adult, skin-burrowing, as well as their larvae and pupae

dog follicle mite, adult, burrowing in hair follicles, as well as their larvae and

pupae flea, adult, bloodsucking, as well as their larvae and pupae

It will be understood that the parasites mentioned above are not confined to the single host animal with which each is here identified. Most parasites inhabit various hosts, although each parasite has a favorite host. For example, the mange mite attacks at least horses, hogs, mules, humans, dogs, cats, foxes, rabbits, sheep, and cattle. Horseflies freely attack horses, mules, cattle, hogs, dogs, and most other animals. My method effectively kills parasites of the types described above growing in the host animals mentioned above, and in other host animals as well. For example, my invention is effective in cats, camels, and zoo animals, etc.

The composition of the invention can also be used for treating plants, such as fruit trees, vegetable, house plants, flowers, trees, spire, or portion thereof, such as fruits, etc.

The composition of the invention can also be in the form of a dispersion suitable for making various coatings on various substrates.

The composition can be used for making porous layer. The coating can be obtained by common pulverisation or spray system or by brushing, by dipping, etc.

The coating can be for rendering a face of a substrate hydrophobic and/or hydrophilic, for preparing coating which can be removed with water under pressure, surface which are easy to clean, surface which has one or more properties, such as insect repellent, nematocides, algicide, anti fungal, anti mollusc, etc. The coating can also be dust repellent or dirt repellent or water repellent.

The composition can also be used for treating manure, animal wastes, etc.

The composition of the invention can be associated to or can comprise one or more luring agents, attractive agents, foods, etc. and mixtures thereof.

The composition of the invention which is already effective when comprising only the hydrophobic coated siliceous nanoparticles, can if required further comprises one or more elements selected from the group consisting of:

compounds suitable for attracting the insect or molluscs, acarides or ticks or parasites or mites to be combated, such as food, sugar, beer, tartaric acid, honey, blood concentrates, fruit syrups, butter acid, carbon dioxide, etc.

compounds for repelling insect or molluscs, acarides or ticks or parasites or mites, dirt or birds;

insecticide compounds, such as chlorinated or fluorinated compounds or ferromone, or dioxine;

solvents, such as aliphatic alcohols, such as water, non polar solvents, such organic solvents, hexane, heptane, terpene, benzene, isoprene, isopar, thinner, methanol, ethanol, isopropylalcohol, ketones, acetone, methyl ethyl ketone, glycol, polyethylene glycol, propyleneglycol, dimethylformamide, dimethyl sulfoxide, acetonitrile, glycol ethers, methylol, dioxalane, polypropylene carbamate, esters, ethers, halogeno solvent, for example chlorinated solvents, such as chlorinated hydrocarbons, 1,2,2 trichloro-1,1,2-trifluoroethane, fluorinated solvents, such as fluorinated hydrocarbons, hydrofluoroethers, mixtures thereof. Typical examples are perfluorohexane, perflorooctane, pentafluorobutane, CF₃CFHFHCF₂CF₃, methylperfluoroethers, ethyl perfluorobutyl ether, trifluoromethyl-3-ethoxydodécafluorhexane, ethyl nonafluoro isobutylether, methyl nonafluoro butyl ether, and mixtures thereof. Preferred fluoro solvents are trifluoromethyl-3-ethoxydodécafluorhexane, ethyl nonafluoro isobutylether, ethyl nonafluoro butylether, methyl nonafluoro butyl ether, methyl nonafluoro isobutyl ether and mixtures thereof.

surfactant and tensioactive agents, such as ammonium, phosphonium, betaine, soap, amidobetaine, sulfonated lignins, the condensed naphthalenesulfonates, the naphthalenesulfonates, the alkylbenzenesulfonates, the alkyl sulfates, and nonionic surfactants such as ethylene oxide adducts of alkyl phenols

germicide,

essential oils, such as tea tree oil, yucca extract, oleoresin capsicum, capsicum, garlic oil, etc.

antibacterial agent,

herbicides,

growth inhibitor or regulator, chitin inhibitors, hormone, pheromone,

anti algae,

antifungal agents,

disintegrant,

solid inert particles, such as calcium carbonate, uncoated silicon dioxide, silicon dioxide, precipitated silica, fumed silica, silicates, bentonite, synthetic hydrated silicon dioxide, diatomaceous earth, attapulgite, hectorite clay, montmorillonite clay, silica gel particles, zeolite (natural or synthetic), etc

acidifying means or buffer agents,

chelating agents, water retention agent (polyacrylamide, bentonite, zeolite),

gums, polysaccharide, cellulose, and their derivatives,

preservatives or vitamins, such as vitamin E,

wax,

polymers, such polymer of acrylic esters and/or methacrylic ester, carboxy vinyl polymer, etc.

chitin and derivatives thereof,

caffeine, capsicum, bitrex, etc.

ammonium, phosphonium, borax, and

mixtures thereof

The composition of the invention is however substantially free of any additives, except of compounds suitable for attracting the parasites to be killed or otherwise combated and inert solid particles. The composition of the invention is advantageously in the form of a powder or in the form of a suspension or in the form of a suspension of siliceous containing particles in a solvent for the coating agent or in the form of granules or pellets or in the form of food additives or in the form of a gel, possibly an aerated gel, or in the form of colloidal medium. When given as food additives to the animals to be protected from the parasites, the parasites present in the digestive path of the animal are combated, while as after its passage in the digestive path, the hydrophobic compound will be released in the excrement, the hydrophobic compound will be active against parasites living in said excrement or lying eggs in said excrement.

The composition of the invention can be applied on the animals or a portion of the animals to be treated. For example, the composition of the invention can be applied on the animal or on a surface where insects or molluscs, acarides or parasites have to be killed, by powdering a dry composition, by spraying a dry or liquid composition, by brushing or painting a dry or liquid composition, rolling the animal or a portion thereof in a dry or liquid bath, by obliging the animal to pass on a dry or liquid bath, by feeding the animal with an aqueous or non aqueous composition or suspension, by dipping the animal or a portion thereof in an aqueous or non aqueous composition, by electrostatic application of the powder on a support, by blowing powder, etc. with or without ultrasonic support, and with or without fluidized bed.

The composition can also be used for application on various substrates, such as seeds, silicon sealing members, etc. for repelling birds, insects, molluscs, acarides or parasites.

The composition can contain particles with a larger particle size. However, the active agent will preferably not contain more than 50% by weight (preferably no more than 10%) of coated siliceous containing particle with an average primary particle size of more than 100 nm, said percentage being calculated on basis of the weight of active particles with an average primary size of less than 100 nm.

The weight ratio active coated siliceous containing nanoparticles/filler and additives is for example comprised between 0.001 and 1000, such as between 0.01 and 100, for example between 0.05 and 20.

The composition of the invention, in dry or liquid forms, can be used in many possible application, such as:

farming applications, for example in poultry, for treating horse, cowshed, etc.

in cosmetic fields, such as for treating hairs, as for example as shampoo, soaps, gel, shower gel, etc.

food, as for poultry, horses, cows, etc.

in household fields, such as for treating carpets, beds, mattress, curtains, textiles, clothes, napkins, etc., the treatment can be made as a dry treatment (dry cleaning) or a wet treatment or a semi dry cleaning, with or without other additives such as washing agents, with or without heat, with or without water vapor, according to an advantageous embodiment, after treating the surface or the object, the composition and the dead insects or molluscs, acarides or parasites are sucked in a sucking device or a vacuum cleaner,

for treating plants, such as interior plants as exterior plants, such as flowers, grapes, trees, fruit trees, vegetable,

for treating seeds, said treatment being carried out advantageously before the storage of the seeds, but can also be carried out just before the plantation of the seeds or during its plantation,

for treating rooms and chamber and confined spaces, such as TV boxes, computer boxes,

for treating grounds or soils or garbage,

for removing from the skin (human skin, animal skin, etc.) bloodsucking parasites;

in pharmaceutical composition for keeping parasite away,

in packaging, for example in closing means, such as reclosable cork or stopper,

for forming anti grafitti walls or surfaces or supports;

for forming walls, surfaces or supports with anti acid rain properties;

for forming walls, surfaces or supports on which excrement, manure, animal waste are repelled;

etc.

The invention relates also to a process for combating insects, mites, ticks, molluscs, parasites, especially blood sucking parasites, in which the insects, mites, ticks or parasites are contacted with a composition of the invention, especially with a composition comprising siliceous containing particles with an outer hydrophobic coating, and/or in which the eggs, larva, pupae, nymphs, etc. of the insects, mites, ticks, parasites, molluscs to be combated are contacted with a composition of the invention.

The invention relates further also to a process for repelling insects, mites, ticks, dirt, birds, molluscs, parasites, especially blood sucking parasites, in which a composition of the invention, especially with a composition comprising siliceous containing particles with an outer hydrophobic coating, repels insects, mites, ticks, dirt, birds, molluscs, parasites, especially blood sucking parasites.

A further object of the invention is a process for preventing troubles to a living organism, such as animals, humans or plants, said troubles being due to insects, mites, ticks, mollusc, dirt, birds and parasites, especially bloodsucking parasites, in which a composition of the invention is applied on at least a portion of the living organism, such as on the skin or the hair or the leather or scalp or feather of the human or animal or the plant, such as the seed thereof.

The invention also relates to a support provided with a composition of the invention, said support being for example: foods, cosmetic composition, pharmaceutical composition, packaging, animals or portions thereof, humans and portion thereof, plants and portions thereof, such as seeds thereof, buildings and portions thereof, grounds, soils, plastic, carpets, furniture, springs, mattress and portion thereof, tissues (woven or non woven), fabrics (woven or non woven), cushions, garments, clothes, metals, recipients, closing means, filter, bands, feather, leather, hair, etc. and mixtures thereof.

As the coated particles of the composition of the invention are not degraded at temperature below 200° C., the particles have a very long time efficiency, as long as there are sufficient particles present for treating the insects, ticks, mites, molluscs and parasites or for repelling the insects, ticks, mites, molluscs and parasites, water, dirt and birds.

The invention relates also to a process for coating siliceous containing particles dispersed in a medium so as to form a colloidal medium with a weight solid content greater than 25%, advantageously greater than 40%, preferably greater than 50%, most preferably greater than 60%, in which a silicon containing coating agent is added to the medium, in which after coating the particles, the medium is dried. The so obtained coated particles are advantageously treated so as to modify the structure of the coated particles. Advantageously, the structure of the siliceous containing particles are modified before and/or during and/or after making the coating treatment, preferably after the coating treatment, most preferably after a drying step (before and/or during and/or after a curing step). For example, the agglomerated nanoparticles forming agglomerates are submitted to treatment for breaking the agglomerates, for example by milling, by micronizing, by ultrasound treatment, by lyophilization, by spraying, by grinding, by mixing in a bath or liquid medium (intensive mixing), and combinations thereof. Reference can be done to US20020077388 for disclosing a specific method for modifying the structure of silicas.

The colloidal medium is advantageously a water free colloidal medium or a substantially water free, and preferably a medium suitable for solubilizing the coating agent. Such a medium is for example alcohols, ethanol, methanol, fluoro solvents, etc., mixtures thereof. The colloidal medium can comprise one or more stabilizers, such as alkali, ammonium hydroxide, sodium hydroxide, potassium hydroxide, lithium hydroxide, triethylamine, dimethylethanol, glycol, ethyleneglycol, diethyleneglycol, dimethylethanol amino, etc. and mixtures thereof.

### EXAMPLES

### Example 1

In said tests, bloodsucking chicken parasites (red blood lice, which was found in industrial laying hen houses) were placed in transparent boxes of 1 liter. The parasites were treated with a various powdered compositions, namely:

(uncoated SiO₂) uncoated silicon dioxide particle with an average primary particle size of about 20 nm;

Al₂O₃ particles

TiO₂ particles;

Hydrophobic coated silicon dioxide particles with a BET surface of 160 m²/g, an average primary particle size of 10 nm, and a carbon content of about 3% (due to the coating) (AEROSIL R 8200—Degussa)

Hydrophobic coated silicon dioxide particles with a BET surface of 260 m²/g, an average primary particle size of 7 nm, and a carbon content of about 3% (due to the coating) (AEROSIL R 812—Degussa)

Hydrophobic coated silicon dioxide particles with a BET surface of 150 m²/g, an average primary particle size of 12 nm, and a carbon content of about 5% (due to the coating) (AEROSIL R 805—Degussa)

Structure modified and with a methacrylsilane after treated fumed silica (AEROSIL R 7200 Degussa) with a BET surface of about 150 m²/g, a carbon content of about 5%, a tapped density of about 230 g/l, a pH (4% by weight dispersion) of about 5, and an average primary particle size of about 10 to 15 nm

In each boxes containing some parasites, an amount of powder was placed for covering 50% of the bottom surface of the box.

Results of the tests is given in the following table

| | Activity of the parasites after | | | | |
|---|---|---|---|---|---|
| Product | 10 minutes | 3 hours | 5 hours | 7 hours | 9 hours |
| Reference | +++ | +++ | +++ | +++ | +++ |
| no treatment | | | | | |
| Uncoated | +++ | +++ | +++ | +++ | +++ |
| SiO₂ | | | | | |
| Al₂O₃ | +++ | +++ | +++ | +++ | +++ |
| TiO2 | +++ | +++ | +++ | +++ | +++ |
| Aerosil R | + | + | +/− | dead | dead |
| 8200 | | | | | |
| Aerosil R | + | + | +/− | dead | dead |
| 812 | | | | | |
| Aerosil R | + | + | +/− | dead | dead |
| 805 | | | | | |
| Aerosil R | + | dead | dead | dead | dead |
| 7200 | | | | | |

+++: very active
+: active
+/−: substantially no activity
dead: all the parasites are dead

As it can be seen from these tests, the composition of the invention had a good efficiency for killing after a reasonable treatment period the parasites.

### Example 2

Aerosil R 8200 was powdered on a portion of a hen house (the powdering being repeated twice a month), so that some laying hens are treated while some other hen were not treated.

It appears from a long term use (more than 12 months) that the treated laying hens had a better health (no dead hens were observed for the treated laying hens, while some dead hens were observed for the non treated hens), and that the eggs of the treated laying hens were substantially not spotted due to the parasites.

No trace of aerosil 8200 were found in the eggs of the treated hens.

### Example 3

Example 2 was repeated, except that an alcohol dispersion of Aerosil R 7200 was sprayed in the hen house, with the hens present.

### Example 4

Example 3 was repeated, except that the treatment was made in the hen house after removing the hens. The treatment was thus made as a preventive treatment.

### Example 5

A commercial shampoo was mixed with aerosil R 7200 particles, so that the particle content of the composition was 5% by weight. It has been observed that the presence of the particles had a small abrading effect during the friction of the shampoo on the hair and that after treatment, all the lice were removed. It has also been observed that some aerosil powder was remaining on the hair, whereby forming a preventing agent against lice.

In the same way a dry shampoo was prepared by adding 5% by weight of Aerosil 7200 in a commercial dry shampoo composition.

### Example 6

A dog with ticks was treated with a glove filled with aerosil 7200 powder. After swabbing the skin of the dog with the glove, the dog was left with the powder for 4 hours. The dog was thereafter brushed so as to remove dead ticks.

The so treated dog had a better resistance against ticks and flea, this being probably due to the presence of some aerosil 7200 dust particles.

### Example 7

A plant colonized with plant louse was treated with a dry spray of aerosil 7200. Three hours after the treatment, the plant louse were killed.

### Example 8

A food flour for chicken was mixed with Aerosil 7200, so that the Aerosil 7200 content was 1%. It has been observed that less lice were present on the dejection of the chicken eating the food flour with the additive, than on the dejection of the chicken not eating the food flour with the additive.

### Example 9

100 g of sugar powder was mixed with 10 g Aerosil 7200 so as to form a mixture suitable for attracting parasite.

### Example 10

An ant nest has been treated with dry powder Aerosil 7200. After three hours, the ants were dead.

### Example 11

A carpet has been treated with a dry powder formulation containing 50% by weight Aerosil 7200. After three hours, the house dust mites were dead. After vacuum cleaning, some aerosil 7200 particles were remaining in the carpet, whereby forming a preventing agent against house dust mites.

### Example 12

Example 11 was repeated except that the formulation comprised substantially only Aerosil 7200.

### Example 13

A garment (such as a head band, a hood, helmet, beret, balaclava, gloves, cover, etc) were dry treated with aerosil 7200 powder. The so treated garment had a preventive effect against parasite.

### Example 14

Example 13 was repeated, except that they were washed with a washing powder comprising 10% by weight of aerosil 7200.

### Example 15

Functionalized Hydrophobic SiO₂ Particles have been Prepared as Follows:

SiO₂ particles have been placed in ethanol so as to form a SiO₂ suspension with a SiO₂ content of 5% by weight. Fluor ammonium silane (produced by 3M) was added to the SiO₂ suspension. The amount of fluor ammonium silane added was equal to 0.1% of the solid weight of the suspension. Ethanol is a solvent for the fluor ammonium silane. (other solvents, such as fluoro solvents can be used). After 30 minutes, the SiO₂ particles provided with a functionalized hydrophobic coating were dried and treated so as to modify the structure of the coated particles. Said structure modification was carried out by intensive mixing After said treatment (structure modification), the average primary particle size of the coated SiO₂ particles was about 7-10 nm.

Functionalized Hydrophobic SiO₂ Particles with a Silanol Layer

SiO₂ particles have been placed in hot water during 10 minutes so as to ensure the formation of a silanol layer at the outer face of the SiO₂ particles. After drying at 100-105° C., the particles have been treated with fluor ammonium silane in ethanol as disclosed here above.

Functionalized Hydrophilic SiO₂ Particles have been Prepared as Follows:

SiO₂ particles have been placed in ethanol so as to form a SiO₂ suspension with a SiO₂ content of 5% by weight. 4-Amino-3,3-dimethyltrimethoxysilane was added to the SiO₂ suspension. The amount of added silane was equal to 0.1% of the weight of the suspension. After 30 minutes, the SiO₂ particles provided with a functionalized hydrophilic coating were dried and treated in a ball mill. The average primary particle size of the coated SiO₂ particles was about 10 nm.

Functionalized Hydrophobic Colloid SiO₂ Particles I have been Prepared as Follows:

A colloidal medium consisting of colloidal SiO₂ particles in ethanol with a solid content of 60% by weight have been treated with fluoro ammonium silane. The amount of fluoro ammonium silane added was equal to 0.1% of the solid weight of the colloidal medium. Ethanol is a solvent for the fluoro ammonium silane. (other solvents, such as fluoro solvents can be used). After 30 minutes, the colloidal medium was dried so as to obtain SiO₂ particles provided with a functionalized hydrophobic coating. The particles were treated so as to modify the structure of the coated particles. Said structure modification was carried out by intensive mixing. After said treatment (structure modification), the average primary particle size of the coated SiO₂ particles was lower than 10 nm.

Functionalized Hydrophobic Colloid SiO₂ Particles II have been Prepared as Follows:

A colloidal medium consisting of colloidal SiO₂ particles in ethanol with a solid content of 60% by weight, said medium comprising a stabilizer (such as triethylamine) have been treated with fluoro ammonium silane. The amount of fluoro ammonium silane added was equal to 0.1% of the solid weight of the colloidal medium. Ethanol is a solvent for the fluoro ammonium silane. (other solvents, such as fluoro solvents can be used). After 30 minutes, the colloidal medium was dried so as to obtain SiO₂ particles provided with a functionalized hydrophobic coating. The particles were treated so as to modify the structure of the coated particles. Said structure modification was carried out by ball milling. After said treatment (structure modification), the average primary particle size of the coated SiO₂ particles was lower than 10 nm.

These particles have been used for treating (combating) blood sucking mites active for chicken and hens. Said blood sucking mites have been placed in boxes. The treatment was made by adding to each box an amount of composition to be tested sufficient for having a substantially complete covering of the bottom of the box.

The compositions used in said example are:

Composition I: funtionalized hydrophobic SiO2 particles

Composition II: funtionalized hydrophilic SiO2 particles

Composition III: 50% by weight funtionalized hydrophobic SiO2 particles+50% by weight funtionalized hydrophilic SiO2 particles

Composition IV: 10% by weight funtionalized hydrophobic SiO2 particles+90% by weight funtionalized hydrophilic SiO2 particles

Composition V: 50% by weight funtionalized hydrophobic SiO2 particles+50% by weight SiO2 particles not provided with a functionalized coating (SiO2 particle with a silanol coating prepared by surface hydrolysis)

Composition VI: Functionalized hydrophobic SiO₂ particles with an inner silanol layer

Composition VII: SiO₂ particles with an outer silanol layer (hydrolysis)

Composition VIII: Functionalized hydrophobic colloid SiO₂ particles I

Composition IX: Functionalized hydrophobic colloid SiO₂ particles II

Results of the tests are given in the following table.

Activity of the bloodsucking mites after a period of treatment of (Time)

| Time | 10 minutes | 1 hour | 3 hour | 5 hour |
|---|---|---|---|---|
| Composition I | + | +/− | dead | dead |
| Composition II | + | +/− | +/− | dead |
| Composition III | + | +/− | dead | dead |
| Composition IV | + | +/− | dead | dead |
| Composition V | + | +/− | dead | dead |
| Composition VI | + | +/− | dead | dead |
| Composition VII | + | + | + | + |
| Composition VIII | + | +/− | dead | dead |
| Composition IX | + | +/− | dead | dead |

+: active
+/−: reduced activity
dead: no activity

### Example 16

Compositions have been prepared by using the following products:

Hydrophobic coated silicon dioxide particles with a BET surface of 160 m²/g, an average primary particle size of 10 nm, and a carbon content of about 3% (due to the coating) (AEROSIL R 8200—Degussa)

Hydrophobic coated silicon dioxide particles with a BET surface of 260 m²/g, an average primary particle size of 7 nm, and a carbon content of about 3% (due to the coating) (AEROSIL R 812—Degussa)

Hydrophobic coated silicon dioxide particles with a BET surface of 150 m²/g, an average primary particle size of 12 nm, and a carbon content of about 5% (due to the coating) (AEROSIL R 805—Degussa)

Structure modified and with a methacrylsilane after treated fumed silica (AEROSIL R 7200 Degussa) with a BET surface of about 150 m²/g, a carbon content of about 5%, a tapped density of about 230 g/l, a pH (4% by weight dispersion) of about 5, and an average primary particle size of about 10 to 15 nm

Hydrophobic bentonite with an average primary particle size of about 7 to 15 nm, with a tapped density of 457 g/l

Xanthan gum

Guar gum

Scleroglucan gum

Polyvinylpyrrolidone (PVP—homopolymer—Agrimer® sold by International Speciality Products, Wayne, N.J., US)

The following table gives the composition of various aqueous preparations (in % by weight, water being the remaining part of the preparations):

| preparation | 1 | 2 | 3 | 4 | 5 | 6 | 7 |
|---|---|---|---|---|---|---|---|
| Aerosil | 20 | | | | | | |
| R8200 | | | | | | | |
| Aerosil | | 25 | | | | | |
| R812 | | | | | | | |
| Aerosil | | | 25 | | | | |
| R805 | | | | | | | |
| Aerosil 7200 | | | | 25 | | 10 | 20 |
| bentonite | | | | | 25 | 15 | 25 |
| Xanthan | 1 | | | | 0.2 | 0.1 | 0.1 |
| gum | | | | | | | |
| Guar gum | | 1 | | | 0.2 | 0.1 | 0.1 |
| Scleroglucan | | | 1 | | | 0.1 | |
| Gum | | | | | | | |
| PVP | | | | 1 | 0.1 | 0.1 | 0.1 |

Tests have been made on mites. For said test a coating was applied on all the surface of the box, except the cover. For comparative purposes, tests have also been made without some gums.

These tests have shown the following results:

the use of guar gum, xanthan gum and scleroglucan gum increases the efficiency of the hydrophobic silicon containing particles.

The use of a combination of guar gum+xanthan gum or guar gum+scleroglucan gum increases the efficiency of the hydrophobic silicon containing particles.

The use of povidone, especially in combination of one or more gums, increases the efficiency of the hydrophobic silicon containing particles.

The use of a combination of hydrophobic silica with hydrophobic bentonite gives a better efficiency than the use of hydrophobic silica or bentonite alone.

The best efficiency is obtained when combining a hydrophobic silica, a hydrophobic bentonite, guar gum, povidone, and one gum selected from the group consisting xanthan gum, scleroglucan gum and mixtures thereof.

The preparations 6 and 7 have been used for coating various substrates, such as walls, ground surfaces, etc.

Comparative tests have shown that the presence of other gums, such as propylcellulose, methylcellulose, arabic gum, locust bean gum, gellan gum was not efficient for improving the efficiency of the composition.

Tests have also shown that the total content of xanthan gum+guar gum+scleroglucan is preferably at least 0.2% by weight.

### Example 17

Further tests have been made with various compounds, for combating parasites (blood sucking chicken parasites, red blood lices). The following table gives the compound used and the efficiency of the treatment after 10 minutes, after 1 hour, after three hours, after 5 hours. In this table, the following reference signs are used, ++ for very active parasites, + for active parasites, +/− for substantially no active parasites, and − for dead parasites (parasites without any activity).

| | Activity | Activity | Activity | Activity |
|---|---|---|---|---|
| | after | after | after | after |
| Composition used | 10 minutes | 1 hour | 3 hours | 5 hours |
| No (control) | ++ | ++ | ++ | ++ |
| Cabosil TS 720 powder | ++ | + | + | +/− |
| Cabosil TS 720 aerated gel | ++ | ++ | ++ | ++ |
| WO 01/36084- | | | | |
| WO 01/80645 | | | | |
| Hydrophobic Bentonite | ++ | + | + | +/− |
| powder with an alkyl | | | | |
| ammonium salt coating | | | | |
| 10 μm-40 μm - powder | | | | |
| Hydrophobic hectorite | ++ | + | + | +/− |
| powder with an alkyl | | | | |
| ammonium salt coating | | | | |
| 10 μm-40 μm - powder | | | | |
| Hydrophobic silica | + | + | + | +/− |
| Aerosil R 805 (powder) | | | | |
| Hydrophobic silica | + | +/− | − | − |
| Aerosil R 7200 | | | | |
| Hydrophobic silica | + | + | +/− | − |
| Aerosil R 8200 | | | | |
| 50% by weight Hydrophobic | + | +/− | − | − |
| silica Aerosil R 7200 + 50% | | | | |
| by weight hydrophobic | | | | |
| bentonite (alkyl ammonium) | | | | |
| 10-40 μm | | | | |
| 25% by weight Hydrophobic | + | +/− | − | − |
| silica Aerosil R 7200 + 75% | | | | |
| by weight hydrophobic | | | | |
| bentonite (alkyl ammonium) | | | | |
| 10-40 μm | | | | |
| 10% by weight Hydrophobic | + | +/− | − | − |
| silica Aerosil R 7200 + 90% | | | | |
| by weight hydrophobic | | | | |
| bentonite (alkyl ammonium) | | | | |
| 10-40 μm | | | | |
| 50% by weight Hydrophobic | + | +/− | − | − |
| silica Aerosil R 8200 + 50% | | | | |
| by weight hydrophobic | | | | |
| bentonite (alkyl ammonium) | | | | |
| 10-40 μm | | | | |
| 25% by weight Hydrophobic | + | +/− | − | − |
| silica Aerosil R 8200 + 75% | | | | |
| by weight hydrophobic | | | | |
| bentonite (alkyl ammonium) | | | | |
| 10-40 μm | | | | |
| 10% by weight Hydrophobic | + | +/− | − | − |
| silica Aerosil R 8200 + 90% | | | | |
| by weight hydrophobic | | | | |
| bentonite (alkyl ammonium) | | | | |
| 10-40 μm | | | | |
| 50% by weight Hydrophobic | + | +/− | − | − |
| silica Aerosil R 8200 + 50% | | | | |
| by weight bentonite | | | | |
| 10-40 μm | | | | |
| 50% by weight Hydrophobic | + | +/− | − | − |
| silica Aerosil R 7200 + 50% | | | | |
| by weight bentonite | | | | |
| 10-40 μm | | | | |
| 50% by weight Hydrophobic | + | +/− | − | − |
| silica Aerosil R 8200 + 50% | | | | |
| by weight hectorite | | | | |
| 10-40 μm | | | | |
| 50% by weight Hydrophobic | + | +/− | − | − |
| silica Aerosil R 7200 + 50% | | | | |
| by weight hectorite | | | | |
| 10-40 μm | | | | |
| 50% by weight Hydrophobic | + | +/− | − | − |
| silica Aerosil R 8200 + 50% | | | | |
| by weight hydrophobic | | | | |
| hectorite (alkyl ammonium | | | | |
| salt coating) | | | | |
| 10-40 μm | | | | |
| 10% by weight Hydrophobic | + | +/− | − | − |
| silica Aerosil R 8200 + 90% | | | | |
| by weight hydrophobic | | | | |
| hectorite (alkyl ammonium | | | | |
| salt coating) | | | | |
| 10-40 μm | | | | |
| 10% by weight Hydrophobic | + | +/− | − | − |
| silica Aerosil R 7200 + 90% | | | | |
| by weight hydrophobic | | | | |
| hectorite (alkyl ammonium | | | | |
| salt coating) | | | | |
| 10-40 μm | | | | |
| 50% by weight Hydrophobic | + | +/− | − | − |
| silica Aerosil R 8200 + 50% | | | | |
| by weight hydrophobic | | | | |
| hectorite (alkyl ammonium | | | | |
| salt coating) 10-40 nm | | | | |
| 50% by weight Hydrophobic | + | +/− | − | − |
| silica Aerosil R 8200 + 50% | | | | |
| by weight hydrophobic | | | | |
| bentonite (alkyl ammonium | | | | |
| salt coating) 10-40 nm | | | | |
| 50% by weight Hydrophobic | + | +/− | − | − |
| silica Aerosil R 7200 + 25% | | | | |
| by weight hydrophobic | | | | |
| hectorite (alkyl ammonium | | | | |
| salt coating) 10-40 μm + 25% | | | | |
| by weight hydrophobic | | | | |
| bentonite (alkyl ammonium | | | | |
| salt coating) 10-40 μm | | | | |
| 50% by weight Hydrophobic | + | +/− | − | − |
| silica Aerosil R 7200 + 15% | | | | |
| by weight hydrophobic | | | | |
| hectorite (alkyl ammonium | | | | |
| salt coating) 10-40 μm + 35% | | | | |
| by weight hydrophobic | | | | |
| bentonite (alkyl ammonium | | | | |
| salt coating) 10-40 μm | | | | |
| 50% by weight Hydrophobic | + | +/− | − | − |
| silica Aerosil R 7200 + 35% | | | | |
| by weight hydrophobic | | | | |
| hectorite (alkyl ammonium | | | | |
| salt coating) 10-40 μm + 15% | | | | |
| by weight hydrophobic | | | | |
| bentonite (alkyl ammonium | | | | |
| salt coating) 10-40 μm | | | | |
| 50% by weight Hydrophobic | + | +/− | − | − |
| silica Aerosil R 7200 + 25% | | | | |
| by weight hectorite | | | | |
| 10-40 μm + 25% by weight | | | | |
| bentonite 10-40 μm | | | | |
| 10% by weight Hydrophobic | + | +/− | − | − |
| silica Aerosil R 7200 + 45% | | | | |
| by weight hectorite | | | | |
| 10-40 μm + 45% by weight | | | | |
| bentonite 10-40 μm | | | | |
| 10% by weight Hydrophobic | + | +/− | − | − |
| silica Aerosil R 7200 + 10% | | | | |
| by weight hydrophobic silica | | | | |
| Aerosil R 8200 + 40% | | | | |
| by weight hectorite | | | | |
| 10-40 μm + 40% by weight | | | | |
| bentonite 10-40 μm | | | | |
| 50% by weight Hydrophobic | + | +/− | − | − |
| silica Aerosil R 7200 + 25% | | | | |
| by weight hydrophilic silica | | | | |
| 10-40 nm + 25% by weight | | | | |
| bentonite 10-40 μm | | | | |

This table shows the good efficiency of the treatment, when using hydrophobic silica with a low average primary particle size, especially when combined with bentonite and/or hectorite.

In the examples, the proportion between hydrophobic silica, bentonite and/or hectorite was varied. From said tests, it seems that a minimum content of hydrophobic silica with a particle size 10-40 nm in the composition for achieving good result is about 1%, while when bentonite and hectorite are present, a minimum content of about 1% seems also preferable.

### Example 18

943.4 g tap water was mixed with 75 g Aerosil R 8200 (structure modified hydrophobic silica particles with an average primary particle size of 10 nm), and then with 1.6 g of a mixture consisting of 50% by weight xanthan gum and 50% by weight guar gum, so as to form a low viscous liquid composition or dispersion. Said composition was still stable after a period of 12 weeks at laboratory ambient conditions (about 20-25° C.).

The composition was sprayed on faces of a box, in which, after drying of the sprayed composition, blood sucking parasites were placed. After 10 minutes, the parasites were substantially no more active.

### Example 19

898 g tap water was mixed with 100 g Aerosil R 8200 with a mixture consisting of 0.66 g Xanthan gum, 0.66 g guar gum and 0.66 g scleroglucan, so as to prepare a liquid composition with a low viscosity. The composition was stable for 12 weeks at laboratory conditions (20-25° C.).

The composition was sprayed on faces of a box, in which, after drying of the sprayed composition, blood sucking parasites were placed. After 10 minutes, the parasites were substantially no more active.

### Example 20

764.2 g tap water was mixed with 100 g Aerosil R 8200, 70 g hydrophobic bentonite (with an alkyl ammonium salt coating) and 58 g hydrophobic hectorite (with an alkyl ammonium salt coating) and then with 7.8 g of a mixture comprising 50% by weight xanthan gum, 25% by weight guar gum and 25% by weight scleroglucan. The so prepared mixture had the form of a stable liquid dispersion with a low viscosity which is stable from −18° C. up to 60° C.

The composition was sprayed on faces of a box, in which, after drying of the sprayed composition, blood sucking parasites were placed. After 10 minutes, the parasites were substantially no more active.

The composition can be diluted with water, for example by adding 1 volume water for each volume of the composition, without phase separation, so as to obtain a more liquid composition, whereby permitting an easier application such as brushing, paint rolling, airless and/or diluted spraying system, such as a hand sprayer or an automatic spraying system with up to 15 nozzles, without any blocking of the nozzles. A greater number of nozzles (more than 15, such as 20, 25, 50) can be used.

Tests have also shown that when using the compositions of the examples 18 to 20 in a hen house, the sprayed surface was active (by combating and/or by repelling the parasites) against the blood mites (without further application) for 140 days for the composition of example 18, for about 210 days for the composition of example 19, and for about 360 days for the composition of example 20.

### Example 21

A dry powder mixture was prepared by mixing 10% by weight Aerosil R7200, 10% by weight Aerosil R8200, 40% by weight hydrophobic bentonite and 40% by weight hydrophobic hectorite. This powder composition is particularly efficient for re treating the surfaces treated with one of the composition of examples 18 to 20.

### Example 22

An aqueous composition was prepared by mixing water, scleroglucan (content 7 g/l), polyvinylpyrrolidone (content 3 g/l), and Aerosil R 8200 (content 80 g/l). The composition was stable and was suitable for application by painting. The so applied composition was dirt resistant and dirt repellent, as well as water repellent.

### Example 23

Example 22 was repeated, except that one or more additives were added.

The following table give the additive added, the achieved added property.

| Example | Additive - concentration | property |
|---|---|---|
| 23A | Flufenoxuron 10 g/l | Anti worm |
| 23B | Azamethiphos 5 g/l | Anti fly |
| | 9-tricosene 5 g/l | |
| 23C | Bitrex 20 g/l | Anti molluscs |
| 23D | Capsaesine 25 g/l | Anti molluscs |
| 23E | Boric acid 5 g/l | Anti ant |
| 23F | Permethrine 5 g/l | Anti insect |
| 23G | Capsicum 20 g/l | Anti bird |
| 23H | Capsicum 20 g/l + Bitrex 20 g/l | Anti bird |

### Example 24

Example 21 has been repeated, except that boric acid (powder) was added at the rate of 2% by weight. The so obtained powder is an anti ant powder.

### Example 25

A composition was prepared by mixing water with cabosil TS720 (80 g/l), xanthan gum 5 g/l, guar gum 5 g/l and 5 g polyvinyl pyrrolidone. It was observed that said composition had a better efficiency than a water composition comprising cabosil TS720 and xanthan gum alone.

### Example 26

Seeds have been treated with the composition of example 22, except that the following additives have been used: Bitrex 20 g/l, permethrine 5 g/l and capsicum 25 g/l. The seeds were covered on all their faces with a layer of said composition.

The so treated seeds were dried.

The dried seeds were stable during the storage and remained without dirt.

After planting the seeds in a soil, it appears that the seeds were repellent for insects, birds and molluscs, enabling therefor a high proportion of correct growing seeds.

### Example 27

Silicon rubber was mixed with a mixture consisting of 80% by weight hydrophobic silica Aerosil R 8200, 10% by weight bentonite (10-40 nm), 5% by weight capsicum and 5% by weight bitrex.

The silicon rubber was used for making sealing member for glass structure.

It was observed that the silicon rubber was bird repellent, as well as dirt and water (such as acid rain) repellent.

What we claim is:

1. Composition for combating at least one living organism selected from the group consisting of insects, molluscs, acarides, mites, ticks and parasites or for repelling at least one element selected from the group consisting of insects, molluscs, acarides, mites, ticks, parasites, water, dirt and birds, said composition comprising at least as active agent hydrophobic silicon (Si) containing particles with an average primary particle size of less than 100 nm.

2. The composition of claim 1, in which the hydrophobic silicon containing particles comprise also some aluminum.

3. The composition of claim 1, which comprises at least 0.5% by weight hydrophobic silicon containing particles with an average primary particle size of less than 100 nm.

4. The composition of claim 1, which comprises at least 2% by weight hydrophobic silicon containing particles with an average primary particle size of less than 100 nm.

5. The composition of claim 1, which comprises at least 7% by weight hydrophobic silicon containing particles with an average primary particle size of less than 100 nm.

6. The composition of claim 1, which comprises at least 15% by weight hydrophobic silicon containing particles with an average primary particle size of less than 100 nm.

7. The composition of claim 1, which comprises hydrophobic silicon containing particles, said particles having an average primary particle size of less than 50 nm.

8. The composition of claim 1, which comprises hydrophobic silicon containing particles, said particles having an average primary particle size comprised between 5 and 40 nm.

9. The composition of claim 1, in which the hydrophobic silicon containing particles have a SiO₂ content of at least 50% by weight.

10. The composition of claim 1, in which the hydrophobic silicon containing particles have a SiO₂ content of at least 80% by weight.

11. The composition of claim 1, in which the hydrophobic silicon containing particles with a primary particle size of less than 100 nm have a BET surface area of at least 40 m²/g.

12. The composition of claim 1, in which the hydrophobic silicon containing particles with a primary particle size of less than 100 nm have a BET surface area of at least 100 m²/g.

13. The composition of claim 1, in which the hydrophobic silicon containing particles with a primary particle size of less than 100 nm have a BET surface area of at least 125 m²/g.

14. The composition of claim 1, in which the hydrophobic silicon containing particles are hydrophobic particles selected from the group consisting of SiO₂ particles, clay and mixtures thereof.

15. The composition of claim 1, in which the active hydrophobic silicon containing particles are hydrophobic clay particles selected from the group consisting of kaolinite, montmorillonite, attapulgite, hectorite, smectite, illite, bentonite, halloysite, vermiculite, sepiolite, beidellite, palygorskite, talc, SiO₂, and mixtures thereof.

16. The composition of claim 1, in which the active hydrophobic silicon containing particles are particles selected from the group consisting of kaolinite, montmorillonite, attapulgite, hectorite, smectite, illite, bentonite, halloysite, vermiculite, sepiolite, beidellite, palygorskite, talc, SiO₂, and mixtures thereof, said particles being provided with a hydrophobic coating.

17. The composition of the preceding claim, in which the hydrophobic coating is made of a silicon containing product selected from the group consisting of chlorosilane, disilazane, fluorosilane, polysiloxane, cyclotetrasiloxane, methacrylic silane, silicon oil, modified silicon oil, and derivatives thereof.

18. The composition of claim 1, which comprises coated silicon containing particles provided with an outer hydrophobic silicon containing coating.

19. The composition of claim 1, which further comprises clay particles with an average particle size greater than 1 μm.

20. The composition of claim 1, which further comprises clay particles with an average particle size comprised between 10 μm and 100 μm.

21. The composition of claim 1, in which the hydrophobic silicon containing particles are particles provided with a hydrophobic silicon containing coating which comprises at least an element selected from the group consisting of functionalized silanes, siloxane, silicon oil, modified silicon oil and mixtures thereof.

22. The composition of claim 1, in which the hydrophobic silicon containing particles are particles provided with a hydrophobic coating comprising at least a compound selected from the group consisting of ammoniums, phosphoniums and mixtures thereof.

23. The composition of claim 1, in which the hydrophobic silicon containing particles are particles provided with a hydrophobic silicon containing coating, whereby said coating comprises at least carbon atoms and at least one or more atoms selected from the group consisting of P,S,O,N, Cl, F, I.

24. The composition of claim 1, in which the hydrophobic silicon containing particles are particles provided with a hydrophobic silicon containing coating which comprises at least one function selected from the group consisting of amino, ureido, thio, halogeno hydrocarbon group, cyano, isocyanato, mercapto, disilazane, acrylic, methacrylic and mixtures thereof.

25. The composition of claim 1, which comprises at least hydrophobic particles selected from the group consisting of hydrophobic bentonite particles, hydrophobic hectorite particles, and mixtures thereof.

26. The composition of claim 1, which comprises at least hydrophobic particles with a size comprised between 1 and 100 μm selected from the group consisting of hydrophobic bentonite particles, hydrophobic hectorite particles, and mixtures thereof.

27. The composition of claim 1, which comprises at least hydrophobic particles with a size comprised between 10 and 100 nm selected from the group consisting of hydrophobic bentonite particles, hydrophobic hectorite particles, and mixtures thereof.

28. The composition of claim 1, which comprises
from 0.01% by weight to 99.99% by weight of hydrophobic silica, and
from 0.01% by weight to 99.99% by weight of hydrophobic clay

29. The composition of claim 28, in which the hydrophobic clay comprises clay particles with a size comprised between 1 μm and 100 μm.

30. The composition of claim 1, which comprises
from 0.01% by weight to 99.99% by weight of hydrophobic silica, and
from 0.01% by weight to 99.99% by weight of hydrophobic particles selected from the group consisting hydrophobic bentonite particles, hydrophobic hectorite particles, and mixtures thereof.

31. The composition of claim 30, in which the hydrophobic particles selected from the group consisting hydrophobic bentonite particles, hydrophobic hectorite particles, and mixtures thereof comprises hydrophobic particles with a size comprised between 1 μm and 100 μm.

32. The composition of claim 1, which has the form of an aqueous dispersion

33. The composition of claim 1, which further comprises at least a gelling agent.

34. The composition of claim 1, which comprises at least a gelling agent selected from the group consisting of water soluble gelling agent and water dispersible gelling agent.

35. The composition of claim 1, which comprises from 0.01 to 10% by weight of gelling agent selected from the group consisting of water soluble gelling agent and water dispersible gelling agent.

36. The composition of claim 1, which comprises from 0.01 to 5% by weight of gelling agent selected from the group consisting of water soluble gelling agent and water dispersible gelling agent.

37. The composition of claim 1, which comprises at least one gum selected from the group consisting of guar gum, xanthan gum, scleroglucan and mixtures thereof.

38. The composition of claim 1, which comprises at least two gums selected from the group consisting of guar gum, xanthan gum and scleroglucan.

39. The composition of claim 1, which further comprises at least one solid agent selected from the group consisting of hydrophobic zeolite, hydrophobic carbonate, and mixtures thereof.

40. The composition of claim 1, which has the form of a water dispersible powder.

41. The composition of claim 1, which is an aqueous composition with a content in hydrophobic silica containing particles with a primary particle size of less than 100 nm comprised between 0.5% and 70% by weight.

42. The composition of claim 1, which is an aqueous composition with a content in hydrophobic silicon containing particles with an average primary particle size of less than 100 nm of at least 2% by weight.

43. The composition of claim 1, which is an aqueous composition with a content in hydrophobic silicon containing particles with an average primary particle size of less than 100 nm of at least 7% by weight.

44. The composition of claim 1, which is an aqueous composition with a content in hydrophobic silicon containing particles with an average primary particle size of less than 100 nm of at least 15% by weight.

45. The composition of claim 1, which further comprises an agent selected from the group consisting of povidone, povidone derivatives, and mixtures thereof.

46. The composition of claim 45, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

47. The composition of claim 1, which further comprises one element selected from the group consisting of compounds suitable for attracting the insect or worm or acaride or molluscs or mites or ticks to be combated, compounds suitable for repelling the insect or worm or acaride or molluscs or mites or ticks or dirt or birds to be repelled, insecticide compounds, solvents, dispersant, tensioactive, surfactant, germicide, antibacterial agent, herbicides, growth regulators, chitin inhibitor, antifungal agents, disintegrant, antialgae, hormones, chelating agents, essential oils, plant extracts, water retention agent, food, anti mollusc compounds, biocides, rodenticides, acaricides, and mixtures thereof

48. The composition of claim 1, which is in a form selected from the group consisting of a powder, a suspension, granules, pellets, food additives, aerated gel, non aerated gel, colloidal medium, cream and combinations thereof.

49. The composition of claim 1, which comprises at least one compound selected from the group consisting of additives and fillers, the weight ratio hydrophobic silicon containing nanoparticles with an average primary particle size lower than 100 nm/compound selected from the group consisting of additive and filler being comprised between 0.001 and 1000.

50. The composition of claim 1, which comprises at least one compound selected from the group consisting of additives and fillers, the weight ratio hydrophobic silicon containing nanoparticles with an average primary particle size lower than 100 nm/compound selected from the group consisting of additive and filler being comprised between 0.01 and 100.

51. The composition of claim 1, which comprises at least one compound selected from the group consisting of additives and fillers, the weight ratio hydrophobic silicon containing nanoparticles with an average primary particle size lower than 100 nm/compound selected from the group consisting of additive and filler being comprised between 0.05 and 20.

52. The composition of claim 1, in which the hydrophobic silicon containing particles are particles provided with an outer layer selected from the group consisting of water soluble layers, entero soluble layers and combinations thereof.

53. The composition of claim 1, in which the silicon containing particles are provided with at least a hydrophilic silicon containing coating and with at least a hydrophobic silicon containing coating.

54. The composition of claim 1, in which the silicon containing particles are particles with a modified structure.

55. Composition for combating at least one living organism selected from the group consisting of insects, molluscs, acarides, mites, ticks and parasites or for repelling at least one element selected from the group consisting of insects, molluscs, acarides, mites, ticks, parasites, water, dirt and birds, said composition comprising at least as active agent hydrophobic particles, and at least two gums selected from the group consisting of guar gum, xanthan gum and scleroglucan.

56. The composition of claim 55, which further comprises an agent selected from the group consisting of povidone, povidone derivatives, and mixtures thereof.

57. The composition of claim 55, which comprises as active agent hydrophobic silicon containing particles with an average primary particle size lower than 100 nm.

58. The composition of claim 54, which comprises an effective amount of hydrophobic silicon containing particles with an average primary particle size lower than 100 nm.

59. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent hydrophobic particles with an average primary particle size of less than 100 nm, and at least one agent selected from the group consisting of povidone, povidone derivatives, and mixtures thereof.

60. The composition of claim 59, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

61. The composition of claim 59, which comprises an effective amount of hydrophobic silicon containing particles with an average primary particle size lower than 100 nm.

62. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent hydrophilic particles with a primary particle size of less than 100 nm, and at least two gums selected from the group consisting of guar gum, xanthan gum and scleroglucan.

63. The composition of claim 62, which further comprises an agent selected from the group consisting of povidone, povidone derivatives, and mixtures thereof.

64. The composition of claim 62, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

65. The composition of claim 62, which comprises an effective amount of hydrophobic silicon containing particles with an average primary particle size lower than 100 nm.

66. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent hydrophilic particles with an average primary particle size of less than 100 nm, and at least one agent selected from the group consisting of povidone, povidone derivatives, and mixtures thereof.

67. The composition of claim 66, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

68. The composition of claim 66, which comprises an effective amount of hydrophilic silicon containing particles with an average primary particle size lower than 100 nm.

69. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent hydrophobic clay with a primary particle size lower than 100 μm.

70. The composition of claim 69, which further comprises at least one agent selected from the group consisting of povidone, povidone derivatives, and mixtures thereof.

71. The composition of claim 69, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

72. The composition of claim 69, which comprises at least a gelling agent selected from the group consisting of water soluble gelling agent and water dispersible gelling agent.

73. The composition of claim 69, which comprises from 0.01 to 10% by weight of gelling agent selected from the group consisting of water soluble gelling agent and water dispersible gelling agent.

74. The composition of claim 69, which comprises from 0.01 to 5% by weight of gelling agent selected from the group consisting of water soluble gelling agent and water dispersible gelling agent.

75. The composition of claim 69, which comprises at least one gum selected from the group consisting of guar gum, xanthan gum, scleroglucan and mixtures thereof.

76. The composition of claim 69, which comprises at least two gums selected from the group consisting of guar gum, xanthan gum and scleroglucan.

77. The composition of claim 69, which comprises hydrophobic clay particles with a particle size greater than 10 μm.

78. The composition of claim 69, which comprises clay particles selected from the group consisting of bentonite, hectorite and mixtures thereof.

79. The composition of claim 69, which comprises hydrophobic clay with a particle size comprised between 1 μm and 100 μm, and hydrophobic clay with a primary particle size comprised between 10 nm and 100 nm.

80. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent coated silicon containing particles, said particles having an average primary particle size of less than 100 nm, whereby the coating is a hydrophilic silicon containing coating.

81. The composition of claim 80, which comprises at least as active agent coated silicon containing particles, said particles having an average primary particle size of less than 50 nm, whereby the coating is a hydrophilic silicon containing coating.

82. The composition of claim 80, which comprises at least as active agent coated silicon containing particles, said particles having an average primary particle size comprised between 5 and 40 nm, whereby the coating is a hydrophilic silicon containing coating.

83. The composition of claim 80, which comprises silicon containing particles coated with a hydrophilic silicon containing coating.

84. The composition of claim 80, in which the hydrophilic coating is overcoated with an outer layer selected among the group consisting of water soluble layers, entero soluble layers and combinations thereof.

85. The composition of claim 80, in which the silicon containing particles are provided with at least a hydrophilic silicon containing coating and with at least a hydrophobic silicon containing coating.

86. The composition of claim 80, in which the coated silicon containing particles are coated particles with a modified structure.

87. The composition of claim 80, which comprises at least 0.5% by weight hydrophilic silicon containing particles with an average primary particle size of less than 100 nm.

88. The composition of claim 80, which comprises at least 2% by weight hydrophilic silicon containing particles with an average primary particle size of less than 100 nm.

89. The composition of claim 80, which comprises at least 7% by weight hydrophilic silicon containing particles.

90. The composition of claim 80, which comprises at least 15% by weight hydrophilic silicon containing particles.

91. The composition of claim 80, in which the hydrophilic silicon containing particles have a BET surface area of at least 125 m²/g.

92. The composition of claim 80, which further comprises at least a gelling agent.

93. The composition of claim 80, which comprises at least a gelling agent selected from the group consisting of water soluble gelling agent and water dispersible gelling agent.

94. The composition of claim 80, which comprises from 0.01 to 10% by weight of gelling agent selected from the group consisting of water soluble gelling agent and water dispersible gelling agent.

95. The composition of claim 80, which comprises at least one gum selected from the group consisting of guar gum, xanthan gum, scleroglucan and mixtures thereof.

96. The composition of claim 80, which comprises at least two gums selected from the group consisting of guar gum, xanthan gum and scleroglucan.

97. The composition of claim 80, which is an aqueous composition with a content in hydrophilic silica containing particles with an average primary particle size of less than 100 nm comprised between 0.5 and 70% by weight.

98. The composition of claim 80, which further comprises an agent selected from the group consisting of povidone, povidone derivatives, and mixtures thereof.

99. The composition of claim 98, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

100. The composition of claim 80, which further comprises from 0.1% to 10% by weight of an agent selected from the group consisting of povidone, povidone derivatives, and mixtures thereof.

101. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent coated silicon containing particles, said particles having an average primary particle size of less than 100 nm, whereby the coating comprises a portion which is a hydrophilic silicon containing coating and another portion which is a hydrophobic silicon containing coating.

102. The composition of claim 101, which comprises coated silicon containing particles, said particles having an average primary particle size of less than 100 nm and being provided with an outer coating comprising a portion which is a hydrophilic silicon containing coating and another portion which is a hydrophobic silicon containing coating.

103. The composition of claim 101, which comprises at least as active agent coated silicon containing particles, said particles having an average primary particle size of less than 50 nm, whereby the coating comprises a portion which is a hydrophilic silicon containing coating and another portion which is a hydrophobic silicon containing coating.

104. The composition of claim 101, which comprises at least as active agent coated silicon containing particles, said particles having an average primary particle size comprised between 5 and 40 nm, whereby the coating comprises a portion which is a hydrophilic silicon containing coating and another portion which is a hydrophobic silicon containing coating.

105. The composition of claim 101, in which the coating selected from the group consisting of hydrophobic coating and hydrophilic coating is overcoated with an outer layer selected from the group consisting of water soluble layers, entero soluble layers and combinations thereof.

106. The composition of claim 101, in which the coated silicon containing particles are coated particles with a modified structure.

107. The composition of claim 106, in which the hydrophobic silicon containing particles have a BET surface area of at least 125 m²/g.

108. The composition of claim 106, which further comprises at least a gelling agent.

109. The composition of claim 106, which comprises at least a gelling agent selected from the group consisting of water soluble gelling agent and water dispersible gelling agent.

110. The composition of claim 106, which comprises from 0.01 to 10% by weight of gelling agent selected from the group consisting of water soluble gelling agent and water dispersible gelling agent.

111. The composition of claim 106, which comprises at least one gum selected from the group consisting of guar gum, xanthan gum, scleroglucan and mixtures thereof.

112. The composition of claim 106, which comprises at least two gums selected from the group consisting of guar gum, xanthan gum and scleroglucan.

113. The composition of claim 106, which is an aqueous composition with a content in silica containing particles with a primary particle size of less than 100 nm comprised between 0.5 and 70% by weight.

114. The composition of claim 106, which further comprises an agent selected from the group consisting of povidone, povidone derivatives, and mixtures thereof.

115. The composition of claim 114, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

116. The composition of claim 106, which further comprises from 0.1% to 10% by weight of an agent selected from the group consisting of povidone, povidone derivatives, and mixtures thereof.

117. The composition of claim 106, which comprises at least 1% by weight-silicon containing particles.

118. The composition of claim 106, which comprises at least 7% by weight silicon containing particles.

119. The composition of claim 106, which comprises at least 15% by weight silicon containing particles.

120. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent:
hydrophilic silicon containing particles, said particles having an average primary particle size of less than 100 nm, and
hydrophobic silicon containing particles, said particles having an average primary particle size of less than 100 nm,
the weight ratio active hydrophilic silicon containing particles/active hydrophobic silicon containing particles being comprised between 1/100 and 100/1.

121. Composition for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, said composition comprising at least as active agent:
hydrophilic silicon containing particles, said particles having an average primary particle size of less than 50 nm, and
hydrophobic silicon containing particles, said particles having an average primary particle size of less than 50 nm,
the weight ratio active hydrophilic silicon containing particles/active hydrophobic silicon containing particles being comprised between 1/50 and 2/1.

122. The composition of claim 120, which comprises at least as active agent:
coated silicon containing particles, said particles having an average primary particle size of less than 100 nm, whereby the outer coating is a hydrophilic silicon containing coating, and
coated silicon containing particles, said particles having an average primary particle size of less than 100 nm, whereby the outer coating is a hydrophobic silicon containing coating,
the weight ratio active silicon containing particles with a outer hydrophilic silicon containing coating/active coated silicon containing particles with an outer hydrophobic silicon containing coating being comprised between 1/100 and 100/1.

123. The composition of claim 120, which further comprises at least a gelling agent.

124. The composition of claim 120, which comprises at least a gelling agent selected from the group consisting of water soluble gelling agent and water dispersible gelling agent.

125. The composition of claim 120, which comprises from 0.01 to 10% by weight of gelling agent selected from the group consisting of water soluble gelling agent and water dispersible gelling agent.

126. The composition of claim 120, which comprises at least one gum selected from the group consisting of guar gum, xanthan gum, scleroglucan and mixtures thereof.

127. The composition of claim 120, which comprises at least two gums selected from the group consisting of guar gum, xanthan gum and scleroglucan.

128. The composition of claim 120, which is an aqueous composition with a content in silica containing particles with an average primary particle size of less than 100 nm comprised between 0.5 and 70% by weight.

129. The composition of claim 120, which further comprises an agent selected from the group consisting of povidone, povidone derivatives, and mixtures thereof.

130. The composition of claim 129, in which the povidone derivative is selected from the group consisting of Polyvinylpyrrolidone, cross linked vinylpyrrolidone, alkylated vinylpyrrolidone copolymers, vinyl acetate/vinyl pyrrolidone copolymers, vinyl pyrrolidone/styrene block copolymers, vinyl ether/maleic anhydride copolymers, vinyl pyrrolidone/dimethylaminoethyl methacrylate copolymers, and mixtures thereof.

131. The composition of claim 120, which further comprises from 0.1% to 10% by weight of an agent selected from the group consisting of povidone, povidone derivatives, and mixtures thereof.

132. The composition of claim 120, which comprises at least 1% by weight silicon containing particles.

133. The composition of claim 120, which comprises at least 7% by weight hydrophobic silicon containing particles.

134. The composition of claim 120, which comprises at least 15% by weight hydrophobic silicon containing particles.

135. A support provided with at least one composition comprising at least as active agent for combating or repelling insects, molluscs, acarides, mites, ticks, dirt and parasites, said active agent being selected from the group consisting of hydrophobic silicon containing particles with a primary particle size of less than 100 nm, hydrophobic clay, guar gum, scleroglucan, xanthan gum, povidone, povidone derivatives, and mixtures thereof.

136. The support of claim 135, which is selected from the group consisting of animals or portions thereof, humans and portion thereof, plants and portions thereof, buildings and portions thereof, grounds, soils, plastic, carpets, furniture, springs, mattress and portion thereof, tissues, fabrics, cushions, garments, clothes, metals, recipients, closing means, filter, bands, feather, leather, hair, and combinations thereof.

137. Process for combating at least one living organism selected from the group consisting of insects, molluscs, acarides, mites, ticks and parasites, or for repelling at least one element selected from the group consisting of insects, molluscs, acarides, mites, ticks, parasites, water, dirt and birds, in which at least one living organism selected from the group consisting of insects to be combated or repelled, mites to be combated or repelled, ticks to be combated or repelled, parasites to be combated or repelled, molluscs to be combated or repelled, acarides to be combated or repelled, birds to be repelled, eggs thereof, larvae thereof, pupae thereof and combinations thereof contact at least one composition for combating or repelling said living organism, said composition being a composition comprising at least hydrophobic silicon containing particles with a primary average particle size of less than 100 nm4.

138. The process of claim 137 for combating or repelling living organisms present on a living body selected from the group consisting of living body with hair, living body with feather.

139. The process of claim 137 for combating blood sucking living organisms.

140. The process of claim 137 for combating blood sucking living organisms present on chicken.

141. The process of claim 137 for combating living organisms causing health problems for plant.

142. Process for preventing troubles to living body selected from the group consisting of humans, animals and plants due to insects, molluscs, acarides, mites, ticks and parasites, in which at least a portion of the living body is contacted with a composition for combating or repelling said living organism, said living organism being selected from the group consisting of insects to be combated or repelled, mites to be combated or repelled, molluscs to be combated or repelled, acarides to be combated or repelled, ticks to be combated or repelled, parasites to be combated or repelled, birds to be repelled, eggs thereof, larvae thereof, pupae thereof, dirt and combinations thereof, said composition being a composition comprising as active agent at least hydrophobic silicon containing particles with a primary particle size of less than 100 nm.

143. Process for combating blood sucking living organisms living on chicken, in which the chicken contacts a composition comprising at least as active agent coated silicon containing particles, said particles having an average primary particle size comprised between 5 and 40 nm and being provided with a coating at least different from a silanol coating.

144. Process for combating blood sucking living organisms living on chicken, in which the chicken contacts a composition comprising at least as active agent hydrophobic silicon containing particles, said particles having an average primary particle size comprised between 5 and 40 nm, and at least two gums selected from the group consisting of guar gum, xanthan gum and scleroglucan

145. Process for combating blood sucking living organisms living on chicken, in which the chicken contacts a composition comprising at least as active agent silicon containing particles provided with a hydrophobic coating, said particles having an average primary particle size comprised between 5 and 40 nm, and at least two gums selected from the group consisting of guar gum, xanthan gum and scleroglucan

146. Process for combating blood sucking living organisms living on chicken, in which the chicken contacts a composition comprising at least as active agent hydrophobic silicon containing particles, said particles having an average primary particle size comprised between 5 and 40 nm, and at least one clay selected among the group consisting of bentonite, hectorite and mixtures thereof.

147. Process for combating blood sucking living organisms living on chicken, in which the chicken contacts a composition comprising at least as active agent hydrophobic silicon containing particles, said particles having an average primary particle size comprised between 5 and 40 nm, and at least an agent selected from the group consisting of povidone, povidone derivatives, and mixtures thereof.

148. Process for combating blood sucking living organisms living on chicken, in which the chicken contacts a composition comprising:
at least as active agent hydrophobic silicon containing particles, said particles having an average primary particle size comprised between 5 and 40 nm,
at least two gums selected from the group consisting of guar gum, xanthan gum and scleroglucan,
at least a clay selected from the group consisting of bentonite, hectorite and mixtures thereof, and
at least an agent selected from the group consisting of povidone, povidone derivatives, and mixtures thereof.
